(19) United States
(12) Patent Application Publication
(10) Pub. No.: US 2007/0133453 A1
(43) Pub. Date: Jun. 14, 2007

(54) System and method for management of a wireless environment

(76) Inventors: Aseem Sethi, Bangalore (IN); Amit Phadnis, Bangalore (IN)

Correspondence Address: FAY KAPLUN & MARCIN, LLP, 15O BROADWAY, SUITE 702, NEW YORK, NY, 10038, US

(21) Appl. No.: 11/294,123

(22) Filed: Dec. 5, 2005

(51) Int. Cl. H04Q 7/00; H04L 12/56

(52) U.S. Cl. 370/328; 370/395.2

(57) ABSTRACT

Described is a system and method for management of a wireless environment. The system may includes a network management arrangement (“NMA”), a wireless mobile unit (“MU”) and an access point (“AP). The AP receives a request for an association from the MU and transmits the request to the NMA. The NMA determines if the request is to be granted as a function of at least one of a plurality of predetermined factors which may include a data traffic load of the AP. If the request is not granted, the NMA determines a further AP to grant the request instead of the AP and instructs the AP to transmit a response to the MU including identification data of the further AP.

### BACKGROUND INFORMATION

A typical wireless network may include a plurality of access points (“APs”) communicating wireless signals over predefined coverage areas. A mobile unit (“MU”) may gain access to the network by communicating with an AP when the MU is located in the corresponding coverage area thereof. The network is typically configured so that the MU may be within the coverage areas of multiple APs at a single time. However, after selecting a particular AP with which to associate, the MU attempts association until successful. That is, if a first request to associate is denied, the MU may transmit further requests until one is granted.

During operation, a single AP may support wireless connections to the network for a plurality of MUs. This AP may be heavily loaded and deny requests to associate from further MUs. The further MU may be unaware of further APs in the network which are not as heavily loaded as the particular AP. Thus, the further MUs are repeatedly denied access to the network, and the further APs are underutilized.

### SUMMARY OF THE INVENTION

The present invention relates to a system and method for management of a wireless environment. The system may includes a network management arrangement (“NMA”), a wireless mobile unit (“MU”) and an access point (“AP). The AP receives a request for an association from the MU and transmits the request to the NMA. The NMA determines if the request is to be granted as a function of at least one of a plurality of predetermined factors which may include a data traffic load of the AP. If the request is not granted, the NMA determines a further AP to grant the request instead of the AP and instructs the AP to transmit a response to the MU including identification data of the further AP.

### BRIEF DESCRIPTION OF THE DRAWINGS

FIG. 1 is an exemplary embodiment of a system according to the present invention;

FIG. 2 is an exemplary embodiment of a method according to the present invention; and

FIG. 3 is an exemplary embodiment a wireless communication frame according to the present invention.

### DETAILED DESCRIPTION

The present invention may be further understood with reference to the following description and the appended drawings, wherein like elements are provided with the same reference numerals. The present invention provides a system and a method for management of a wireless environment. During operation, operating conditions of devices in the wireless environment may be evaluated to efficiently allocate resources thereof.

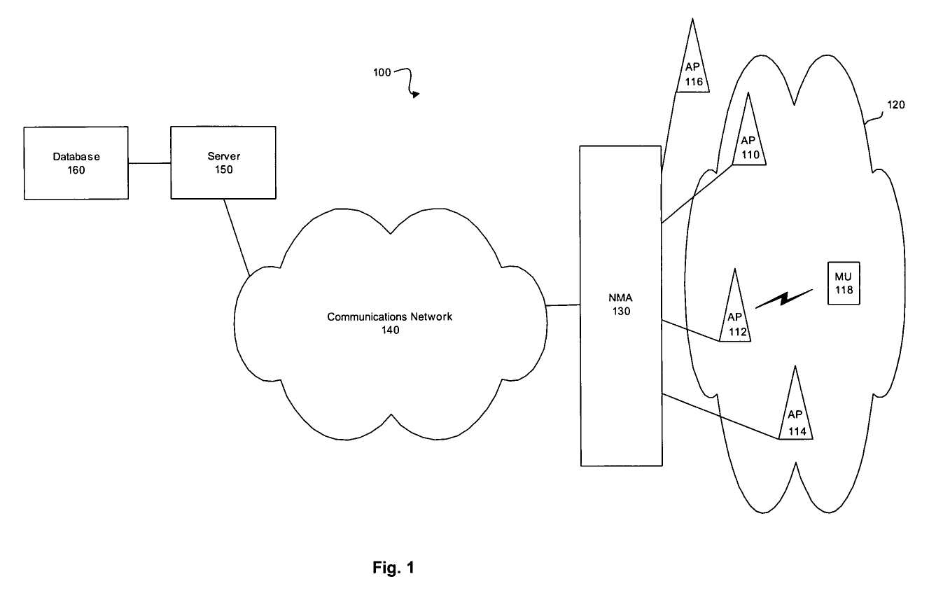

FIG. 1 shows an exemplary embodiment of a system 1 according to the present invention. The system 1 may include a network management arrangement (“NMA”) 130 in communication with a server 150 via a communications network 140. The server 150 may include or be coupled to a database 160. The NMA 130 may include one or more network computing devices (e.g., a server, a database, a router, a switch, etc.) for sending and receiving data requests. The NMA 130 may be responsible for managing the network 140 and any devices coupled thereto. For example, the NMA 130 may store data about an operating condition (e.g., an operational status, an RF coverage, a medium access control (“MAC”) address, a physical location, etc.) of the devices in the network 140, which may facilitate management and operation thereof, as will be explained in detail below.

In one embodiment, the NMA 130 provides access to the network 140 for one or more wireless local area networks (“WLANs”) 120. As shown in FIG. 1, the WLAN 120 may include one or more APs 110, 112, 114 which provide a wireless connection for one or more mobile units (“MUs”) 118 to the network 140. Those skilled in the art will understand that the WLAN 120 may include any number of APs and MUs. The WLAN 120 may also include an AP 116 which may not be included in the WLAN 120, because an RF range of the AP 116 does not extend to the MU 118. The APs 110-116 may be any wireless infrastructure devices (e.g., a wireless hub, a router, a switch, etc.) which provide wireless access to the network 140 for the MU 118.

The MU 118 may be any mobile computing unit, such as, for example, a laser/image-based scanner, an RFID reader/tag, a cell phone, a laptop, a network interface card, a handheld computer, a PDA, etc. In a preferred embodiment, the MU 118 includes a wireless communications arrangement (e.g., a transceiver) allowing it to wirelessly communicate with the APs 110-114 according to a predetermined wireless communications protocol (e.g., an IEEE 802.1x protocol). In this manner, the MU 118 may transmit/receive RF signals to/from the APs 110-114, thereby allowing the MU 118 to communicate with devices connected to the network 140.

Each AP 110-116 broadcasts a beacon at a predetermined interval which may be heard by MUs within the corresponding coverage areas. A beacon header contains a source address (e.g., a Basic Service Set (“BSS”) identifier or MAC address) identifying the coverage area for the corresponding AP. Each beacon may further include a WLAN identifier (e.g., an Extended Service Set (“ESS”) identifier). Transmission of the beacons synchronizes devices on the WLAN 120. As shown in FIG. 1, the MU 118 hears the beacons transmitted by the APs 110, 112, and 114, because the MU 118 is in the corresponding coverage areas thereof.

The MU 118 may initiate a connection to the network 140 by first performing a scan, or “listening,” for the beacons. Upon receiving the beacons therefrom, the MU 118 may select a particular AP (e.g., AP 112) as a function of data contained in or computed from the beacons. For example, the data may include a Received Signal Strength Indicator (“RSSI”) value for each beacon, a number of MUs already associated with each AP, and a location of the MU 118 relative to each AP. The MU 118 may select the AP 112, because its beacon had a highest RSSI. After selecting the AP 112, the MU 118 transmits a request to associate attempting to gain access to the network 140.

In an exemplary embodiment of the present invention, the AP 112 forwards the request to the NMA 130 which performs a connection admission algorithm (e.g., a call admission control) to determine whether the request should be granted by the AP 112. The NMA 130 may evaluate a network load (e.g., number of MUs associated, type (e.g., voice/data) of MUs associated, aggregate throughput, processor utilized, memory free, etc.) of each AP 110-116 in the network 140. However, in the exemplary embodiment, the NMA 130 may exclude the AP 116 from the connection admission algorithm because a location of the MU 118 is outside of the coverage area of the AP 116

Evaluation of the network load on the AP 112 may reveal that the AP 112 is heavily loaded (e.g., an inadequate amount of bandwidth exists for the AP 112 to establish and/or maintain a reliable connection with the MU 118), or that the AP 112 may support a reliable connection for the MU 118 which will not experience congestions, dropped data packets/VoIP calls, etc. The NMA 130 may further evaluate the network load on at least one additional AP (e.g., the APs 110, 114) which is capable of communicating with the MU 118. When the AP 112 is loaded to capacity or substantially to capacity and would not provide a reliable connection for the MU 118, the NMA 130 determines an AP to grant the request to associate as a function of the network loads on the APs and/or whether the MU 118 is within the corresponding coverage areas thereof. When the AP 112 is unsuitable for any reason, the NMA 130 instructs the AP 112 to deny the request in a response message which includes an instruction to the MU 118 to choose another AP (e.g., the AP 114) when retransmitting the request.

Regarding FIG. 1, the connection admission algorithm may be more clearly understood by example. The MU 118 transmits the request to associate to the AP 112, which forwards it to the NMA 130. The NMA 130 evaluates the network load of the AP 112 to determine whether the connection for the MU 118 is supportable. When the AP 112 is not heavily loaded, the NMA 130 instructs the AP 112 to grant the request from the MU 118. When the AP 112 cannot support the connection because, for example, the network load is at a capacity or substantially at the capacity of the AP 112, the NMA 130 analyzes the network loads on the APs 110, 114 which include the MU 118 in their corresponding coverage areas.

If the NMA 130 determines the network load on either of the APs 110, 114 is lighter than the network load of the AP 112 or that it may positively impact the MU 118 and/or the network 140, the NMA 130 selects an AP (e.g., AP 114) which may grant the request to associate when received from the MU 118. For example, the NMA 130 may determine that the AP 114 has a greater amount of bandwidth available to communicate with the MU 118. Thus, NMA 130 instructs the AP 112 to send a response message to the MU 118 denying the request. However, the response message further includes data indicating that the AP 114 may grant the request. Those of skill in the art will understand that the data may include any number of APs which may support the connection of the MU 118 as determined by the evaluation of network loads by the NMA 130.

Although the connection admission algorithm is described as being performed during association of the MU 118 and the AP 112, those of skill in the art will understand that the algorithm may be performed by the AP 112 at run-time. For example, at run-time, the NMA 130 may instruct the AP 112 to refuse the request to associate, and transmit the instruction to redirect the MU 118 to the AP 114.

In another exemplary embodiment of the present invention, the APs 110-116 may share information (e.g., the network load) with one another without use of the NMA 130. For example, if the MU 118 attempts to associate with the AP 112 and it is heavily loaded, the AP 112 may identify the network load(s) of at least one further AP within a predefined range thereof. Preferably, the predetermined range encompasses all of the further APs which may communicate with the MU 118. That is, the AP 112 checks which MUs are in a communicable range of the at least one further AP (e.g., AP 114). The AP 112 compares its network load to the other network loads and grants/denies the request. If the AP 112 denies the request, the response message to the MU 118 may include the instruction to transmit the further request to the AP (e.g., AP 114) with, for example, a lighter network load.

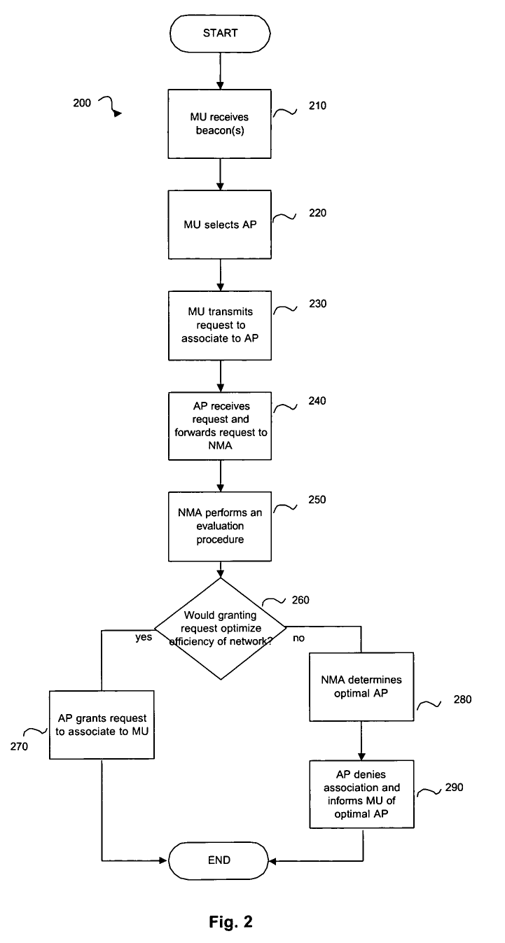

FIG. 2 shows an exemplary embodiment of a method 200 according to the present invention. As discussed above, each AP in the network broadcasts its beacon at a corresponding predetermined interval. The beacon may be received by the MU 118 if it is within the corresponding coverage area of the transmitting AP. Those of skill in the art will understand that the MU 118 may receive beacons from APs which it is not currently associated with.

In step 210, the MU 118 receives the beacon(s) from the AP(s). As shown in FIG. 1, the MU 118 receives the beacons from the APs 110, 112 and 114. In step 220, the MU 118 selects an AP to associate with as a function one or more parameters (e.g., RSSI of the beacon). In the exemplary embodiment, the MU 118 selects the AP 112, because the beacon from the AP 112 had a highest signal strength of all the beacons received by the MU 118.

In step 230, the MU 118 transmits the request to associate to the AP 112. In step 240, the AP 112 receives the request and forwards it to the NMA 130. Alternatively, the AP 112 may transmit data to the NMA 130 indicating that an MU has requested association therewith and optionally including a current network load on the AP 112. As described above, the network load may include a number and type of each MU associated with the AP 112, a duration of the connection of each MU, aggregate throughput, processor utilized, memory free, etc. Alternatively, the NMA 130 may harvest the data (e.g., the network load, etc.) from the APs at a predetermined interval.

In step 250, the NMA 130 performs an evaluation procedure determining whether the AP 112 may support the connection of the MU 118, or whether another AP may provide a more reliable connection. The NMA 130 may compare the network load of the AP 112 to a predetermined threshold value or the network load(s) of at least one further AP (e.g., the AP 110, 114). The NMA 130 may further identify a number of APs which are in a communicable range of the MU 118, a number/type of connections supported by those APs, etc.

In step 260, the NMA 130 determines whether granting the request to associate would optimize efficiency of the network 140 while providing a reliable connection for the MU 118. In the determination, the NMA 130 may account for the network load at the APs, as well as the other above-mentioned factors. Additionally, the NMA 130 may account for a type of communication initiated by the MU 118. For example, when the MU 118 initiates a VoIP call, the connection provided thereto may provide a quality-of-service factor, whereas transfer of data packets (e.g., emails, web requests) need not be provided the quality-of-service.

In step 270, the NMA 130 determines that the AP 112 granting the request would optimize the efficiency of the network 140 and instructs the AP 112 to grant the request. In this instance, the AP 112 may not be substantially loaded and/or be capable of providing the quality-of-service to the MU 118.

In step 280, the NMA 130 determines which of the APs 110, 114 would provide the reliable connection for the MU 118, because the AP 112 is heavily loaded, at a full capacity and/or any other reason why allowing the MU 118 to connect to the network 140 through the AP 112 would negatively impact efficiency of the network 140. This may be the case if the AP 112 does not have the requisite bandwidth available to establish and maintain a reliable connection with the MU 118. Or, the AP 112 may sustain the connection, but the NMA 130 determines that connection with another AP (e.g., the AP 114) is a more efficient allocation of network resources. For example, the AP 114 may be underutilized supporting substantially less connections than the AP 112.

Thus, in step 290, the NMA 130 instructs the AP 112 to transmit the response message to the MU 118 denying the request to associate. However, the response message includes an instruction to transmit the further request to the AP 114. The MU 118 automatically transmits the further request to the AP 114, or may use the instruction when determining which AP to transmit the further request to. For example, in the latter instance, the MU 118 receives the beacons from the APs and measures the signal strength of each. After the MU 118 makes a preliminary selection based on the signal strength, the MU 118 may take into account the instruction regarding the advice of the NMA 130. That is, while the AP 112 exhibits the highest signal strength, the MU 118 may transmit the further request to the AP 114 for a more reliable connection to the network 140.

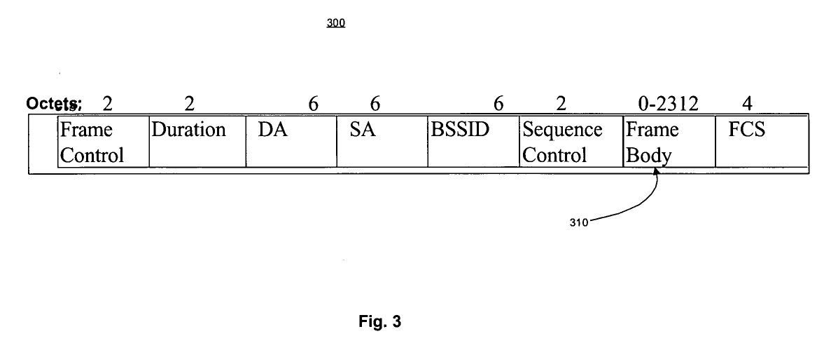

FIG. 3 shows an exemplary embodiment of a management frame 300 which may be utilized as the response message from the AP 112 to the MU 118. A frame body 310 may include an additional attribute or field (e.g., a type-length-value) encoding the instruction indicative of the AP 114. For example, the instruction may include an identifier of the AP 114, such as a BSSID or a MAC address. The frame body 310 of the frame 300 includes one or more Fixed Parameters (e.g., a time-stamp, an interval between beacon emissions, and capability information) and one or more Tagged Parameters. The additional attribute including the instruction may follow the Tagged Parameter(s) in the frame body 310.

Those of skill in the art will understand that the additional attribute may be backward-compatible, because wireless devices which encounter an attribute type that they do not understand merely ignore the attribute. For example, an MU not utilizing the present invention may simply ignore the additional attribute and continue operation.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
receiving a request from a wireless mobile unit (“MU”) for an association with an access point (“AP”);
determining if the request is to be granted as a function of at least one of a plurality of predetermined factors, the predetermined factors including a data traffic load of the AP; and
if the request is not granted, performing the following substeps:
(i) determining a further AP to grant the request instead of the AP, and
(ii) transmitting a response to the MU including identification data of the further AP.

2. The method according to claim 1, wherein the MU includes at least one of an image-based scanner, a laser-based scanner, an RFID reader, an RFID tag, a cell phone, a PDA and a network interface card.

3. The method according to claim 1, wherein the data traffic load of the AP includes at least one of (i) a number of MUs associated with the AP, (ii) a type of each MU associated with the AP, (iii) an aggregate throughput at the AP, (iv) a processing power utilized by the AP, (v) an amount of free memory at the AP and (vi) a bandwidth utilized by the AP.

4. The method according to claim 1, wherein the substep (i) includes the following substep:
identifying a plurality of APs in a communicable range of the MU; and
selecting the further AP from the plurality of APs as a function of data traffic loads at the corresponding APs.

5. The method according to claim 4, wherein the further AP has a lowest data traffic load than each of the plurality of APs.

6. The method according to claim 1, wherein the determining step includes the following substep:
when the data traffic load is greater than a predetermined threshold, denying the request.

7. The method according to claim 1, wherein the determining step includes the following substep:
inputting the at least one predetermined factor into a connection admission algorithm to generate output data; and
determining whether to grant the request as a function of the output data.

8. The method according to claim 1, wherein the identification data includes one of a BSSID and a MAC address of the further AP.

9. A system, comprising:
a network management arrangement (“NMA”);
a wireless mobile unit (“MU”); and
an access point (“AP) receiving a request for an association from the MU, the AP transmitting the request to the NMA,
wherein the NMA determines if the request is to be granted as a function of at least one of a plurality of predetermined factors, the predetermined factors including a data traffic load of the AP, and
wherein, if the request is not granted, the NMA determines a further AP to grant the request instead of the AP and instructs the AP to transmit a response to the MU including identification data of the further AP.

10. The system according to claim 9, wherein the MU includes at least one of an image-based scanner, a laser-based scanner, an RFID reader, an RFID tag, a cell phone, a PDA and a network interface card.

11. The system according to claim 9, wherein the data traffic load of the AP includes at least one of (i) a number of MUs associated with the AP, (ii) a type of each MU associated with the AP, (iii) an aggregate throughput at the AP, (iv) a processing power utilized by the AP, (v) an amount of free memory at the AP and (vi) a bandwidth utilized.

12. The system according to claim 9, wherein the NMA identifies a plurality of APs in a communicable range of the MU and selects the further AP from the plurality of APs as a function of data traffic loads at the corresponding APs.

13. The system according to claim 12, wherein the further AP has a lowest data traffic load than each of the plurality of APs.

14. The system according to claim 9, wherein when the data traffic load is greater than a predetermined threshold, the NMA instructs the AP to deny the request.

15. The system according to claim 9, wherein the NMA utilizes a connection admission algorithm to determine whether the request should be granted.

16. The system according to claim 9, wherein the identification data includes one of a BSSID and a MAC address of the further AP.

17. The system according to claim 9, wherein the NMA is a switch.

18. An arrangement, comprising:
a memory;
a communications arrangement receiving a request from a wireless mobile unit (“MU”) to associate with an access point (“AP”); and
a processor determining if the request is to be granted as a function of at least one of a plurality of predetermined factors, the predetermined factors including a data traffic load of the AP,
wherein, if the request is not granted, the processor determines a further AP to grant the request instead of the AP and instructs the AP to transmit a response to the MU including identification data of the further AP.

19. The arrangement according to claim 18, wherein the arrangement is one of the AP and a switch.

20. The arrangement according to claim 18, wherein the data traffic load of the AP includes at least one of (i) a number of MUs associated with the AP, (ii) a type of each MU associated with the AP, (iii) an aggregate throughput at the AP, (iv) a processing power utilized by the AP, (v) an amount of free memory at the AP and (vi) a bandwidth utilized.

21. The arrangement according to claim 18, wherein the processor identifies a plurality of APs in a communicable range of the MU and selects the further AP from the plurality of APs as a function of data traffic loads at the corresponding APs.
